(19) United States
(12) Patent Application Publication
(10) Pub. No.: US 2010/0083610 A1
(43) Pub. Date: Apr. 8, 2010

(54) Installation pilot device and method

(76) Inventor: Robert King, Laconia, NH (US)

Correspondence Address: KENYON & KENYON LLP, ONE BROADWAY, NEW YORK, NY, 10004, US

(21) Appl. No.: 12/287,012

(22) Filed: Oct. 2, 2008

(51) Int. Cl. E04F 21/00; B25C 3/00; E04B 1/38

(52) U.S. Cl. 52/749.1; 227/148; 52/745.21

(57) ABSTRACT

An installation pilot device includes: a base having a bottom surface and a top surface, the bottom surface being arranged to couple to a top surface of a first construction member; a bore extending through the base at an angle in the range from 50 to 70 degrees with respect to the lower surface, the bore configured to receive a fastener to be driven therethrough; a first positioning stop and a second positioning stop, each of the first and second positioning stops extending from the lower surface, the first and second positioning stops configured to receive the first construction material therebetween when the lower surface is coupled to the top surface of the decking board, and an immovable handle attached to the top surface of the base, wherein the base, the first positioning stop, and the second positioning stop are formed as a single monolithic piece.

### FIELD OF THE INVENTION

The present invention relates to an installation pilot device and method.

### BACKGROUND

In accordance with a typical method of installing decking boards, the boards are placed over a series of joists. The boards are sequentially positioned in a spaced apart arrangement, usually starting from a first side of the deck area, and secured to the joists by driving fasteners, e.g., nails, screws, or hybrid fasteners (e.g., threaded fasteners designed to be driven by a hammer or a screwdriver or pneumatic device), vertically down and perpendicularly through the board and into the joist. Since the fasteners are driven through the top face of the board, the tops of the fasteners are exposed, which may be aesthetically unappealing. Further, if a fastener works out of its fully driven position, the top or cap of the fastener may catch on shoes or bare feet on the surface of the deck. An additional disadvantage of this method of fastening is that the fasteners extend perpendicularly to both the boards and the joists, which may not be an ideal angle from a strength standpoint. “Hidden” fastener systems have been designed to provide a more aesthetically pleasing deck assembly. Examples of such systems are described in the article “Fasteners for All Types of Decking,” Justin Fink, Fine Homebuilding 178, pp. 78-82, May 1, 2006.

Edge mount fasteners involve attaching flanged fasteners to the side edges of the boards and driving screws or other second fasteners to secure the flanged fasteners to the joists. The flanged fasteners may include pointed projections (see, e.g., the Tiger Claw™ fastening system) that are driven into the side of the board. To drive the board into the pointed projections, a sledgehammer is typically used, with a buffer such as a two-by-four piece of lumber to prevent damage to the decking board. Other edge mount fasteners require a longitudinal groove to be formed on each side of the boards and running the length thereof, the longitudinal groove receiving the flange of these fasteners to hold the boards down onto the joist to which the flanged fasteners are attached. These grooves have a substantial negative impact on the strength of the board.

None of these edge mount fasteners are truly hidden, as they are still visible when viewed from above in the gap between adjacent decking boards. These fasteners may be unsightly especially where the fasteners may rust. Further, substantial portions of these fasteners are exposed to the outdoor environmental conditions, e.g., rain and sunlight, which may negatively impact the reliability of the fasteners. For example, plastic fasteners may weaken due to the ultraviolet exposure from the sunlight, and metal fasteners may corrode or rust due to moisture/rain. Further, these fasteners typically reduce the number of points of fastening between the decking boards and the joists or deck frame. This may result in a deck that is structurally weaker than other systems that have more points of fastening, e.g., the top-down fastening method described above.

These fasteners also typically require flat and straight boards for proper installation. If a board needs to be replaced for any reason, e.g., due to physical damage, its removal is very difficult, generally requiring adjacent boards to be removed in order to access the board that needs to be replaced. These systems offer the additional drawback that they add substantial installation costs (related to both hardware and labor) over the typical top-down fastening installation described above.

Other hidden fasteners include undermounts, which mount to the top or side surface of the deck frame and typically have holes that allow screws to be driven upwardly into the decking boards. These installations require access from the bottom of the deck frame while having downward pressure applied to the top of the boards to hold the boards to the frame while driving the screws into the boards. These installation systems also add substantial installation costs (related to both hardware and labor) over the typical top-down fastening installation described above.

### SUMMARY

According to an example embodiment of the present invention, an installation pilot device is provided for facilitating the joining of a first construction member to a second construction member. The installation pilot device includes: a base having a bottom surface and a top surface, the bottom surface being arranged to couple to a top surface of the first construction member; a bore extending through the base at an angle in the range from 50 to 70 degrees with respect to the lower surface, the bore configured to receive a fastener to be driven therethrough; and a first positioning stop and a second positioning stop, each of the first and second positioning stops extending from the lower surface, the first and second positioning stops arranged to receive the first construction material therebetween when the lower surface is coupled to the top surface of the decking board. The installation pilot device also includes an immovable handle attached to the top surface of the base. The base, the first positioning stop, and the second positioning stop are all formed as a single monolithic piece.

The angle in a more preferred embodiment may be in the range from 55 to 65 degrees. In an even more preferred embodiment, the angle may be in the range from 57 to 61 degrees. In a particularly preferred embodiment, the angle is about 59 degrees.

The first and second positioning stops may be spaced apart by a predetermined distance selected to accommodate a width of the first construction member.

According to another example embodiment, an installation pilot device includes: a base having a lower surface arranged to couple to a top surface of a decking board; a first bore extending through the base and forming an angle selected from a range of 50 to 70 degrees with respect to the lower surface; and a second bore extending through the base and forming an angle selected from a range of 50 to 70 degrees with respect to the lower surface, axes of the first and second bores being coplanar and non-parallel with respect to each other. The installation pilot device also includes a first positioning stop and a second positioning stop, each of the first and second positioning stops extending from the lower surface, the first and second positioning stops arranged to receive the decking board therebetween when the lower surface is coupled to the top surface of the decking board. The installation pilot device also includes a handle attached to the base.

The installation pilot device may be symmetric about at least two planes, wherein the two planes may be perpendicular to each other. One of the at least two planes may be the plane that contains the axes of the first and second bores. At least one of the at least two planes may be perpendicular to the plane that contains the axes of the first and second bores.

The magnitude of the angle formed by the first bore may be the same as the magnitude of the angle formed by the second bore. The angles formed by the first and second bores may be selected from a range of 55 to 65 degrees. In a more preferred embodiment, each of the angles formed by the first bore and the second bore is selected from a range of 57 to 61 degrees. In a particularly preferred embodiment, each of the angles formed by the first and second bores is about 59 degrees.

According to another example embodiment of the present invention, a fastened article includes: a decking board having a bottom surface and two adjacent side surfaces at right angles to the bottom surface; a joist having a top surface, the fastener extending through the top surface of the joist to connect the decking board to the joist; and a plurality of fasteners. Each fastener has an axis that intersects each of (a) one of the side surfaces of the decking board, (b) the bottom surface of the decking board, and (c) the top surface of the joist, thereby connecting the decking board to the joist, the fastener forming an angle selected from the range of 50 to 70 degrees, more preferably 55 to 65 degrees, even more preferably, 57 to 61 degrees, and in a particularly preferred embodiment, the angle is about 59 degrees with respect to the bottom surface. The board is formed from a composite building material, the composite building material including a foamed substrate having a foamed inner core and a dense integral skin, wherein the foamed substrate comprises a polymer matrix and a reinforcing filler.

The plurality of fasteners may be the only fasteners connecting the decking board to the joist.

The fastener may be a screw.

The composite building material may further include a urethane/acrylic coating applied to at least one surface of the foamed substrate, wherein the coating includes an IR-reflective pigment and wherein the urethane/acrylic coating is chemically and/or physically bound to the substrate.

According to another example embodiment of the present invention, a method of joining a decking board to a joist, includes: placing a decking board on a joist; positioning an installation pilot over the decking board, the installation pilot including a bore forming a predefined angle with the decking board; placing a fastener into the bore of the installation pilot; and driving the fastener through the bore into a side surface of the decking board and through a bottom surface of the decking board and through a top surface of the joist. The fastener is driven and countersunk to a depth that conceals the fastener when the decking board is viewed from above, and the decking board is formed from a composite building material, the composite building material including a foamed substrate having a foamed inner core and a dense integral skin. The foamed substrate comprises a polymer matrix and a reinforcing filler.

The installation pilot may include a locating structure extending below the plane of the top surface of the decking board when the installation pilot is positioned over the decking board.

The predefined angle may be in the range of 50 to 70 degrees, more preferably in the range of 55 to 65 degrees, even more preferably in the range of 57 to 61 degrees, and in a particularly preferred embodiment, the predefined angle is about 59 degrees.

The method may also include coupling a spacer to the decking board, the spacer being separate from the installation pilot. The spacer may include two spacing projections that extend downwardly to contact respective opposite side surfaces of the decking board. The spacing projections may be tapered and/or a plurality of spacers may be coupled to the decking board.

The installation pilot device allows fasteners to be driven at a depth and angle that is controlled in a simple, accurate, and repeatable manner. Further, the installation pilot device provides stability which aids in the quick and efficient use of the device to install the first construction members. This provides, e.g., consistent, repeatable, and reliable positioning of the installation pilot device on the first construction member and alignment of the fastener with respect to the first construction member with minimal effort on the part of the installer. Further, the positioning of the first construction member between the positioning stops allows the board to be easily and quickly manipulated by moving the installation pilot device. The installation pilot device thus allows the installation of a fastening mechanism that provides the aesthetic benefits of a hidden fastener system, but with little of the added time, effort, cost, and difficulty of other hidden fastener systems.

### BRIEF DESCRIPTION OF THE DRAWINGS

FIG. 1A is a top perspective view of an installation pilot device according to an example embodiment of the present invention.

FIG. 1B is a side view of the installation pilot device illustrated in FIG. 1A.

FIG. 1C is a top view of the installation pilot device illustrated in FIG. 1A.

FIG. 1D is a cross sectional view of the installation pilot device taken along line A-A in FIG. 1C.

FIG. 1E is a front view of the installation pilot device illustrated in FIG. 1A.

FIG. 2 is a front view of an installation pilot device according to an example embodiment of the present invention.

FIG. 3 illustrates a driver bit according to an example embodiment of the present invention.

FIG. 4A illustrates a fastener according to an example embodiment of the present invention.

FIG. 4B illustrates a fastener according to an example embodiment of the present invention.

FIG. 5A illustrates the fastener illustrated in FIG. 4 when inserted into the installation pilot device illustrated in FIG. 1A.

FIG. 5B illustrates the fastener illustrated in FIG. 4 when inserted into the installation pilot device illustrated in FIG. 1A and engaged by the driver bit illustrated in FIG. 3.

FIG. 5C illustrates the fastener illustrated in FIG. 4 after being driven through the installation pilot device illustrated in FIG. 1A to the maximum depth allowed by the driver bit illustrated in FIG. 3.

FIGS. 6A and 6B illustrates the installation pilot device when coupled to a first construction member that is coupled to a second construction member.

FIG. 6C illustrates the first and second construction members illustrated in FIG. 6a when fastened together.

FIG. 7A is a side view of an installation pilot device according to an example embodiment of the present invention.

FIG. 7B is a top view of the installation pilot device illustrated in FIG. 7A.

FIG. 7C is a cross sectional view of the installation pilot device taken along line B-B in FIG. 7B.

FIG. 8 illustrates a portion of the installation pilot device illustrated in FIG. 1A with a second positioning stop having an alternative geometry.

FIG. 9 illustrates a spacer, a first construction member, and a second construction member according to an example embodiment of the present invention.

FIG. 10 is cross sectional view of an installation pilot device according to an example embodiment of the present invention.

### DETAILED DESCRIPTION

Example embodiments of the present invention offer the advantage of a fastening system that does not add substantial costs over the typical top-down installation while providing essentially invisible fastening when viewed from above the gap between adjacent boards. Further, example embodiments provide increased strength between the decking boards and the deck frame as compared to both the typical face-down installation and the conventional “hidden” fastening systems. This added strength is due in part to the angles at which the fasteners are driven.

Example embodiments of the present invention involve driving fasteners, e.g., standard fasteners or specialized fasteners, into side surfaces of the decking boards or other construction member at an angle and extending downward through the bottom surface of the board and into the joist or other construction member. Thus, at an intersection of a decking board and a joist, two fasteners are installed on opposite sides of the decking board, each extending downwardly and inwardly. The angle with respect to horizontal may be approximately 59 degrees. This driving angle allows the cap of the fastener to clear the adjacent boards when the fastener is driven through the gap therebetween, e.g., when a standard gap of 3/16 of an inch is provided. This angle is preferred not only in that it allows the screws to clear the boards while engaging a substantial amount of decking material, but insofar as it has been shown that angles in this approximate range have given improved strength over other angles between wood members—as much as approximately 50% over perpendicularly driven fasteners. See Blass et al., “Screws with Continuous Threads in Timber Connections,” Joints in Timber Structures, RILEM Proceedings PRO 22, September 2001.

Driving screws into a side surface of a decking material at such an angle would not typically lead to good results with wood or typical composite decking materials since splitting and mechanical failure are likely to occur as a result of the proximity of the fastener to the edge of the board and the correspondingly small amount of material between the fastener and the outside of the board. The fastening system of the present invention becomes especially effective when used with decking boards formed of a specific type of decking material such as that described in U.S. patent application Ser. No. 12/012,126, which is incorporated herein in its entirety by reference thereto. This material has a hard and strong outer shell that allows the angle fasteners to be effective as compared to other materials, such as natural wood, which may split, or other composite materials, which may allow the fastener to shear through the material when stress is applied to the board. It is the combination of the improved composite material and the angled fastening that leads to an extremely strong connection between the decking board (or other construction member) and the joist (or other construction member).

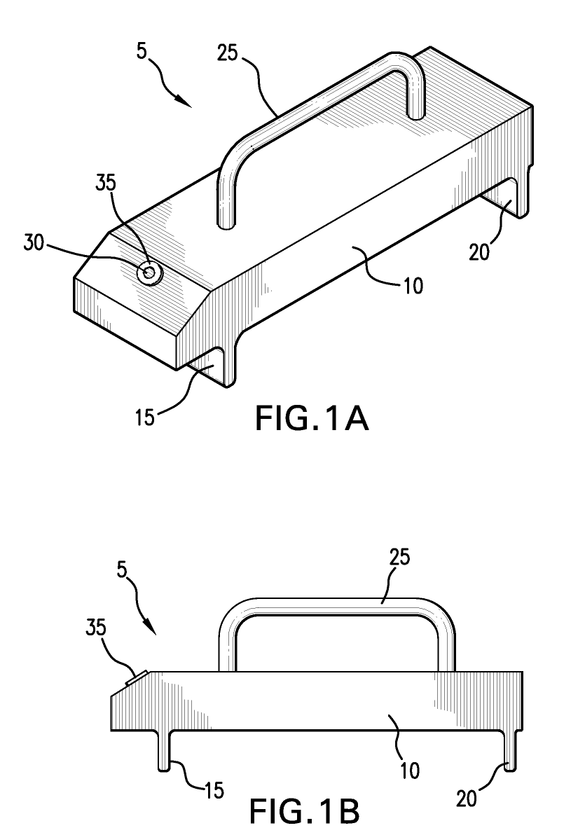

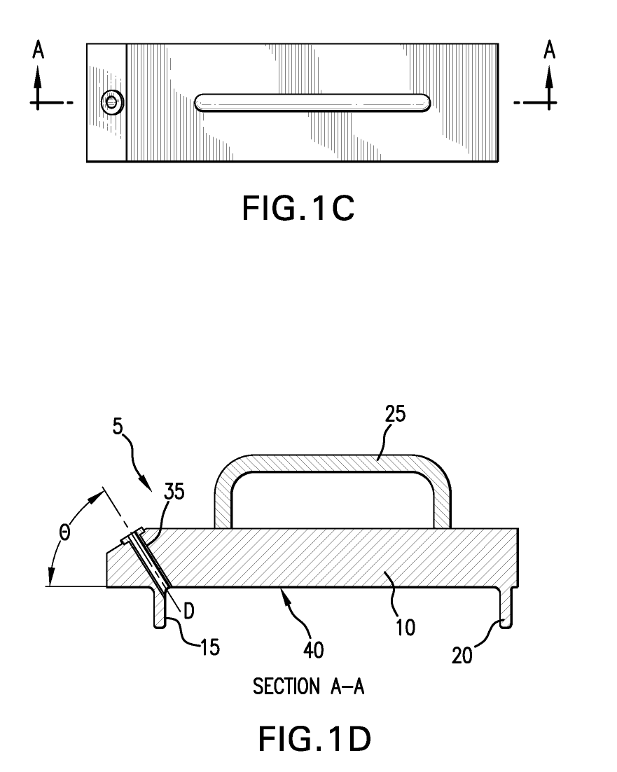

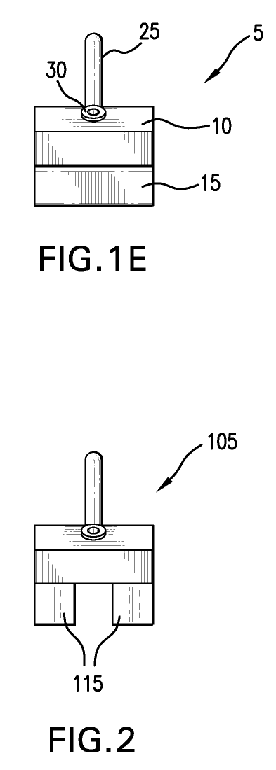

An installation pilot device 5 of the present invention is illustrated in FIGS. 1A to 1E. The installation pilot device 5 includes a base 10 that may be formed from any appropriate material, e.g., plastic or metal. The base includes a first positioning stop 15 and a second positioning stop 20 each of which extends in the downward direction from the body 5. Although the positioning stops 15 and 20 are formed as a single monolithic piece with the base 5, it should be appreciated that the positioning stops 15 and/or 20 may be formed as separate pieces of the same or a different material and attached to the base. For example, at least one of positioning stops 15 and 20 may be formed as a metal piece that is attached to a plastic base 5. Further, neither of the positioning stops 15 or 20 needs to be a single extension (see, e.g., the example illustrated at FIG. 2, described below).

Attached to the top of the base is a handle 25 that allows a user to easily hold and position the installation pilot device 5.

At an end of the base 5 is a bore 30 that extends through the base. The diameter of the bore 30 is defined by a grommet 35 that is attached to the base 5 to form a bushing or bearing surface along the bore. The grommet 35 may be formed of any appropriate material and may be more wear resistant than the material of the base 5. For example, the grommet 35 may be formed of a metal such as bronze that is inserted into the base 5, which may be plastic. The grommet may be desirable to prevent wear from sliding and/or rotation of fasteners and/or driver bits (such as those described below), which may have sharp edges or points. It should be appreciated however, that the grommet may be omitted such that the diameter of the bore 5 is defined by a hole in the base, with the material of the base exposed.

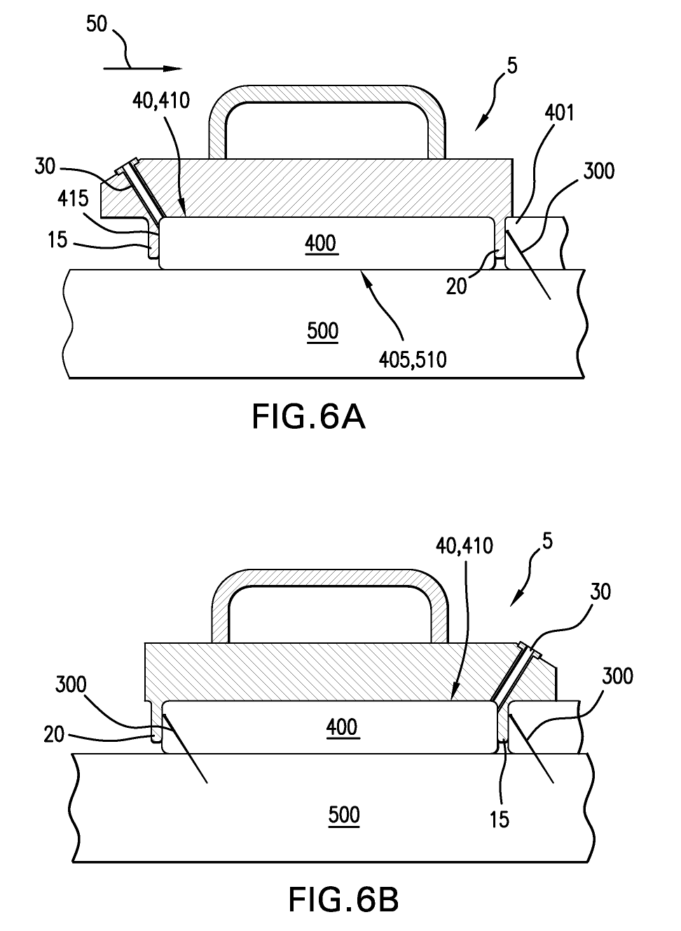

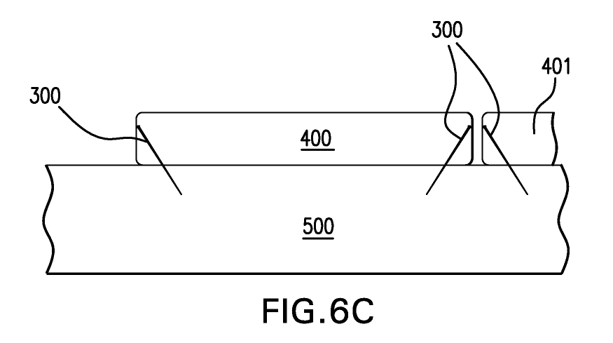

Referring to FIG. 1D, the axis D of the bore 5 forms an angle theta (0) with respect to a bottom surface 40 of the installation pilot device 5. The bottom surface 40 corresponds with a top surface of a first construction member (e.g., the first construction member 400 shown in FIGS. 6A to 6C, described below). Thus, when the installation pilot device 5 is coupled to the first construction member the bore forms the angle theta with the top surface of the first construction member. Further, if the first construction member is positioned horizontally, e.g., where the first construction member is a decking board, the bore 30 forms the angle theta with a horizontal plane when the installation pilot device 5 is coupled to the first construction material. It is noted that the angle theta is measured when viewing the installation pilot device from a side view that is perpendicular to the length of the installation pilot device. Stated another way, the angle is determined by projecting the axis D onto a plane that would be perpendicular to the length of a first construction member that may be received between the first and second positioning stops 15 and 20. Although the axis D of the illustrated installation pilot device falls within such a plane, it should be appreciated that the axis D may be skewed to be angled with respect to this plane. The angle theta would still be determined, however, by projecting the axis onto the plane perpendicular to the first construction material.

FIG. 2 illustrates an installation pilot device 105 that is identical to the installation pilot device 5, except that the installation pilot device 105 includes a first positioning stop 115 and a second positioning stop (not shown), each of which includes two downward projections that allow the axis D of the bore 30 to pass therebetween. This spacing apart may protect the device from potential binding after a fastener is driven into a first construction material, since the driving of the fastener (described in greater detail below) may cause a certain degree of localized bulging of the outer surface of the first construction member.

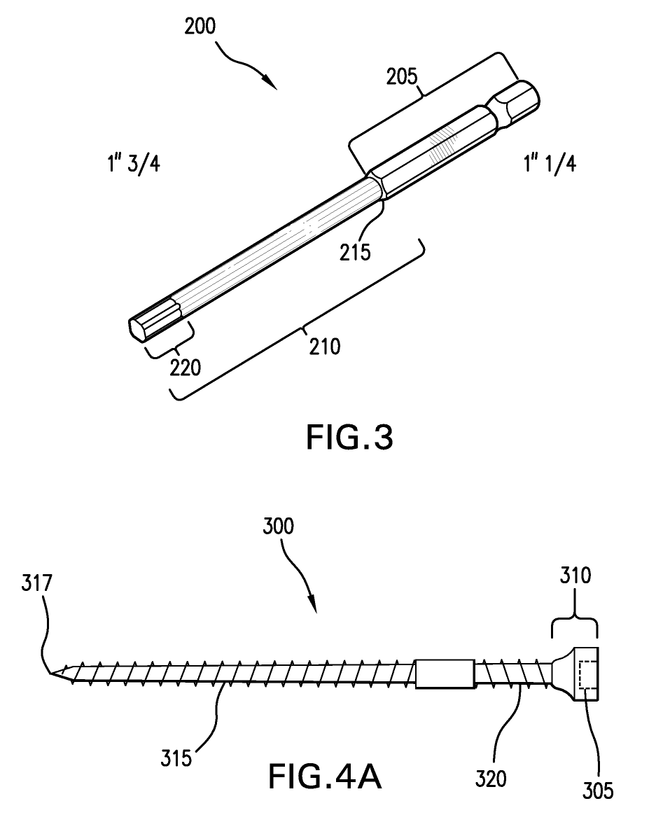

FIG. 3 illustrates a driver bit 200 having a first portion 205 separated from a second portion 210 at a shoulder 215. The first portion 205 has a geometry that allows the driver bit 205 to be gripped and rotated by a driver (e.g., an electric screwdriver). Although the first portion 205 is shown with a continuous hexagonal cross-section, it should be appreciated that any appropriate geometry may be provided.

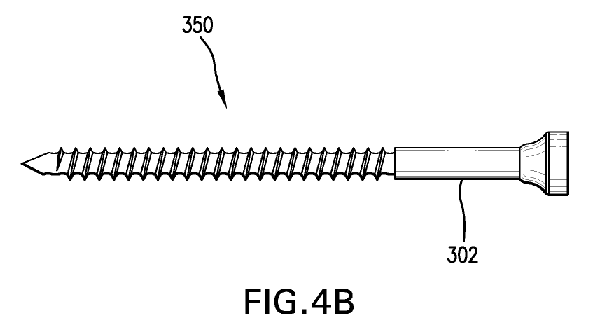

The second portion 210 has a driving portion 220 that functions as a male structure to mate with a corresponding female structure 305 in a head or cap portion 310 of a fastener 300, which is illustrated, e.g., in FIG. 4A. In this manner the driver bit 200 functions to transfer torque from a driver, which couples to the first portion 205, to the fastener 300, which couples to the driving portion 220. Although the driving portion 220 is star-shaped with six radial projections that mate with six corresponding grooves of the head or cap portion 310 of the fastener 300, it should be appreciated that any appropriate mating geometry, e.g., square, may be provided. The star-shaped geometry along with the depth that the driving portion 310 extends into the female structure 305 provides resistance to stripping of the head or cap portion 310 when a large amount of torque is transferred to the fastener 300, e.g., when driving the fastener 300 through multiple construction members.

The diameter of the first portion 205 is larger than the diameter of the second portion 210. In this regard, the second portion 210 has a diameter that is less than the diameter of the bore 30, so as to allow the second portion 205 to extend into and rotate within the bore 30 when the driver bit 200 is driving a fastener through the bore. The first portion 205 has a diameter that is larger than the diameter of the bore 30. Thus, when the driver bit 200 is advanced along the axis D during driving, the depth to which the driver enters the bore 30 is limited by a hard or positive stop caused by the shoulder contacting a flange portion of the grommet 35 (or, if no grommet is provided, an outer surface of the base 5). Thus, the depth to which the fastener 300 is driven is controlled in a simple, accurate, and repeatable manner.

Referring to FIG. 4A, the fastener 300 includes forward threads 315 disposed toward a tip 317 and reverse threads 320 disposed toward the head or cap portion 310. In this regard, the tip is very sharp, e.g., to pierce the hard outer shell of the composite material of the first construction member described herein. Once the outer surface is pierced, rotation of the fastener 300 in a driving direction, e.g., clockwise, causes the forward threads 315 to pull the fastener into the material of the first construction member. When the reverse threads 320 are pulled into the material by the rotation of the forward threads, the same rotation (e.g., clockwise) causes the reverse threads to cut a hole into the construction member to remove material to accommodate the volume of the fastener. Particularly toward the outer surface of the first construction member, this may resist any tendency of the material to bulge when the fastener 300 is fully driven into its fastened position.

Although the reverse threads 320 may have advantages, they may present difficulty in removal of the fasteners. In this regard, a more preferred fastener 350, illustrated in FIG. 4B may be provided. The fastener 350 is identical to the fastener 300 described above, except that a smooth shank portion 302 is provided in place of the reverse threads. Although a particular fastener 300 or 350 may be referred to in connection with the description of the drawings, it should be appreciated that fastener 300 may be used in place of fastener 350, and vice-versa.

Although the fasteners 350 and 300 includes feature that may be highly advantageous for particular applications, it should be appreciated that any appropriate fasteners, e.g., nails or standard screws, may be driven through the installation pilot device.

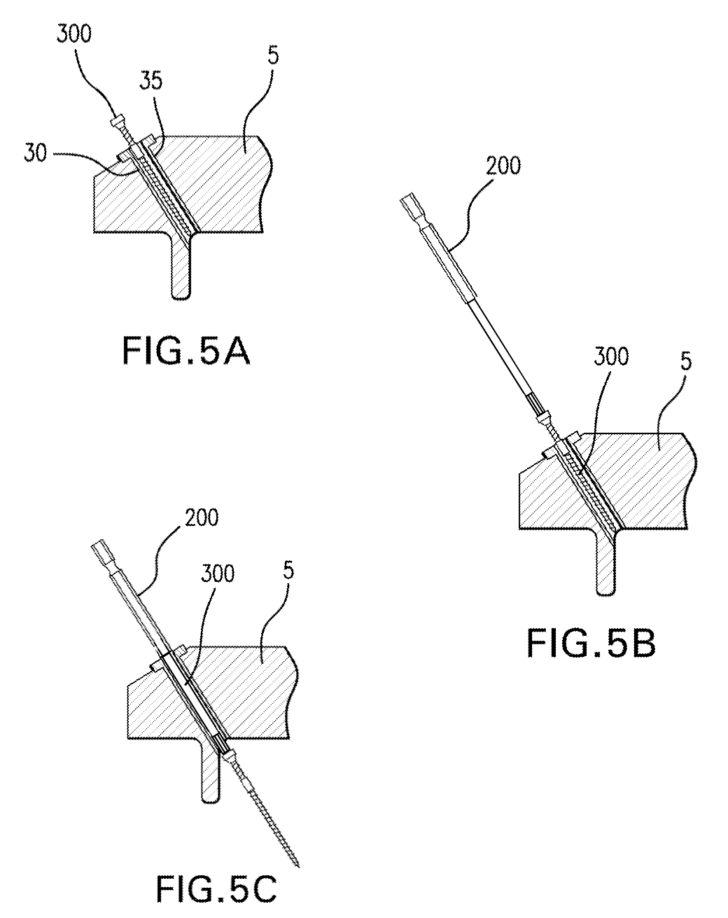

FIGS. 5A to 5C illustrate the advancement of the fastener 300 as it is driven through the installation pilot device 5 with the driver bit 200. Referring to FIG. 5A, a fastener 300 has been placed within the bore 30 of the installation pilot device 5. At FIG. 5B, the driver bit 200 has been mated with the fastener 300. It should be appreciated, however, that the driver bit 200 may be coupled to the fastener 300 prior to insertion of the fastener 300 into the bore 30. The driver bit 200 is then pushed along the axis of the bore and rotated by a driver, e.g., a powered screwdriver, to rotate and drive the fastener 300 into a material, e.g., the first construction member 400 and second construction member 500 illustrated in FIGS. 6A to 6C. At FIG. 5C, the shoulder 215 of the driver bit 200 has engaged the installation pilot device 5, thus preventing further advancement of the driver bit 200 into the bore 30. The installer typically stops the driver once the shoulder 215 contacts the installation pilot device 5. If the installer does not stop driving, the driver bit 200 may, however, continue to rotate with the shoulder contacting the installation pilot device 5. Thus, in this arrangement, the fastener 300 may continue to be driven such that the female structure 305 slides down the driving portion 220 until the driving portion 220 no longer engages the fastener 220. Alternatively, the driver bit 200 may be prevented from rotating due to additional resistance, e.g., due to inability to overcome the frictional force between the driving portion 220 of the bit 200 and the female structure 305 of the fastener 300 and/or due to frictional forces between the shoulder 215 and the installation pilot device 5. After the fastener 300 is driven, the driver bit 200 is pulled from the bore 20 and the installation pilot device 5 may be moved to the next location where a next fastener 300 may be driven.

FIGS. 6A to 6C illustrate the fastening of a first construction member 400 to a second construction member 500. In this example, the first construction member 400 is a decking board formed from the composite material described herein, and the second construction member 500 is a joist, e.g., a wood beam running transverse to the decking board.

As illustrated in FIGS. 6A to 6C, for a given first construction member, a fastening system in accordance with the present invention uses only the fasteners that are driven at the particular angle to the exclusion of other unsightly and costly hidden fasteners. Thus, there are no supplemental fasteners, e.g., biscuits, brackets, etc., which are costly, difficult to install, and may be unsightly. The efficiency and effectiveness of the fastening mechanism illustrated in FIGS. 6A to 6C is made possible by the installation pilot device. In this regard, the installation pilot device allows a fastening mechanism that is simple, strong, hidden, and easy to install (e.g., by a single individual), thus avoiding complexity and limiting costs by saving time and dispensing with the need for costly supplemental fasteners of other hidden fastener systems.

Further, the installation pilot device provides stability which aids in the quick and efficient use of the device to install the first construction members. This stability is enhanced by the presence of structures (e.g., positioning stops 15 and 20) that extend down along both sides of the first construction member. This provides, e.g., consistent, repeatable, and reliable positioning of the installation pilot device on the first construction member and alignment of the fastener with respect to the first construction member with minimal effort on the part of the installer. Further, the positioning of the first construction member between the positioning stops allows the board to be easily and quickly manipulated by moving the installation pilot device. The installation pilot device thus allows the installation of a fastening mechanism that provides the beauty of a hidden fastener system, but with little of the added time, effort, cost, and difficulty of other hidden fastener systems.

The first construction member is desirably formed from a composite material. The composite material preferably includes a foamed substrate having a foamed inner core and a dense integral skin, where the foamed substrate includes a polymer matrix and a reinforcing filler. The composite material preferably also includes a urethane/acrylic coating applied to at least one surface of the foamed substrate, the coating preferably being chemically and/or physically bound to the substrate. The coating preferably includes an infrared-reflective pigment. A preferred polymer matrix is PVC and the reinforcing filler is preferably a non-cellulosic material. A preferred reinforcing filler is calcium carbonate.

The reinforcing filler may preferably be in the foamed composite material in an amount of about 15 to about 50 parts per hundred relative to the PVC, more preferably about 18 to about 25 parts per hundred relative to the PVC.

The urethane/acrylic coating may include aluminum oxide, which may preferably be present in the coating in an amount of about 1% to about 4% by weight.

The infrared reflective pigment may be an infrared-reflective mixed metal oxide and/or may be present in the coating in an amount of about 10% to 20% by weight.

The composite material is preferably extruded. The mixture of ingredients for extrusion includes the polymeric matrix material. Suitable polymeric matrix materials may include, but are not limited to, poly (vinyl chloride) (PVC), chlorinated PVC, polyethylene, polypropylene, polystyrene, styreneacrylonitrile, acrylonitrile butadiene styrene, acrylic/styrene/acrylonitrile block terpolymer (ASA), polycarbonates, polyurethane, and co-polymers or combinations thereof. The composition may include one or more polymeric matrix materials. In preferred embodiments, the polymeric matrix material is a PVC resin. When, as is preferred, PVC is the polymeric matrix material, a stabilizer may be used to inhibit the dehydrochlorination of the PVC and prevent burning of the PVC during the process in the extruder.

The reinforcing filler(s) provides improved strength to the finished composite material 100 according to the present invention. The reinforcing filler preferably has a high surface area to weight that provides reinforcement to the polymer matrix. In preferred embodiments, the filler is an inorganic, non-fibrous material such as calcium carbonate, calcium sulfate, talc, etc., and is most preferably calcium carbonate.

Referring to FIG. 6A, an adjacent first construction member 401 has already been fastened to the second construction member 500, e.g., by the driving of fasteners 300 using the installation pilot device 5. The first construction member 400 is positioned transversely and atop the second construction member 50 at a distance from the adjacent first construction member 401. In this regard, a bottom surface 405 of the first construction member contacts an upper surface 510 of the second construction member 500. The installation pilot device is coupled to the first construction member 400 such that the bottom surface 40 of the installation pilot device 5 contacts the upper surface 410 of the first construction member 400, such that the first construction member 400 is received between the first positioning stop 15 and the second positioning stop 20. The first and second positioning stops 15 and 20 are spaced apart to be provide a space that is only slightly wider than the width of the first construction member 400, so that the deck pilot may easily slide onto and off of the first construction member, but maintaining the ability to accurately manipulate the position of the first construction member 400 with the installation pilot device. For example, the board may be pushed in a forward direction 50 as illustrated in FIG. 6A, or in the rearward direction, without excess play between the positioning stops and the first construction member 400.

As illustrated in FIG. 6A, the installation pilot device 5 has been coupled to the first construction member 400 and the installation pilot device 5, carrying the first construction member 400, has been pushed in the forward direction 50 so that the second positioning stop 20 contacts the adjacent first construction member 401. Thus, the second positioning stop 20 serves to space apart the first construction member 400 and the adjacent first construction member 401. As the first construction member 400 is held in this position, a fastener 300 is driven through the bore 30, e.g., in the manner described above with regard to FIGS. 5A to 5C. The fastener 300 is shown in its driven position on the left side of the first construction member 400 in FIG. 6B.

The fastener 300 is driven at an angle theta described above corresponding to the angle of the bore and is driven through a side surface 415 and down through the bottom surface 405 of the first construction member 400 and the upper surface 510 of the second construction member 500, thereby fastening the first construction member 400 to the second construction member 500 without being visible on the upper surface 410 of the first construction member 400. This may allow for a more visually appealing arrangement, as the fasteners 300 are essentially hidden. Further, this mechanism of hiding fasteners may dispense with other potentially more complex and costly fastening mechanisms, such as, e.g., brackets or biscuit attachments.

Referring to FIG. 6B, the installation pilot device has been removed from the first construction member 400 and reversed so that the bore 30 is disposed on the opposite side of the first construction member 400. As illustrated, the installation pilot device 5 provides a path along the bore 30 that guides the fastener into the gap between the first construction member 400 and the adjacent construction member 401, while protecting the upper surfaces and corners of both the first construction member 400 and the adjacent construction member 401. After the fastener 300 has been driven therethrough, e.g., as described above in regard to FIGS. 5A to 5C, the installation pilot device 5 may be removed from the first construction member and moved to a different location along the first construction member 400, or positioned on the next sequential first construction member to be installed.

The angle theta described above may be any appropriate angle and may be optimized for particular variables, e.g., materials, spacing between adjacent construction member, fastener qualities, etc. For a spacing of 3/16 of an inch, the angle theta may be desirably selected as about 59 degrees. This provides an ideal angle to allow the head of the fastener to pass through the gap while clearing the top surfaces of the adjacent first construction members, while allowing the fastener to be driven sufficiently inwardly into the side of the first construction material.

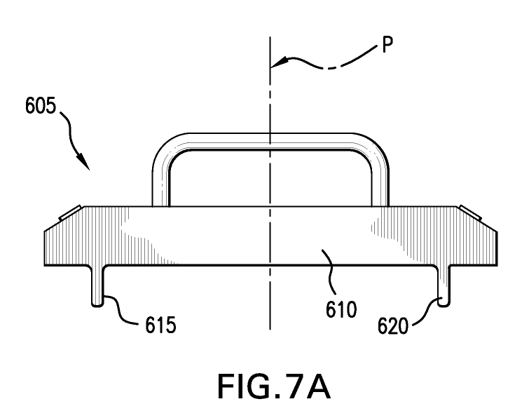

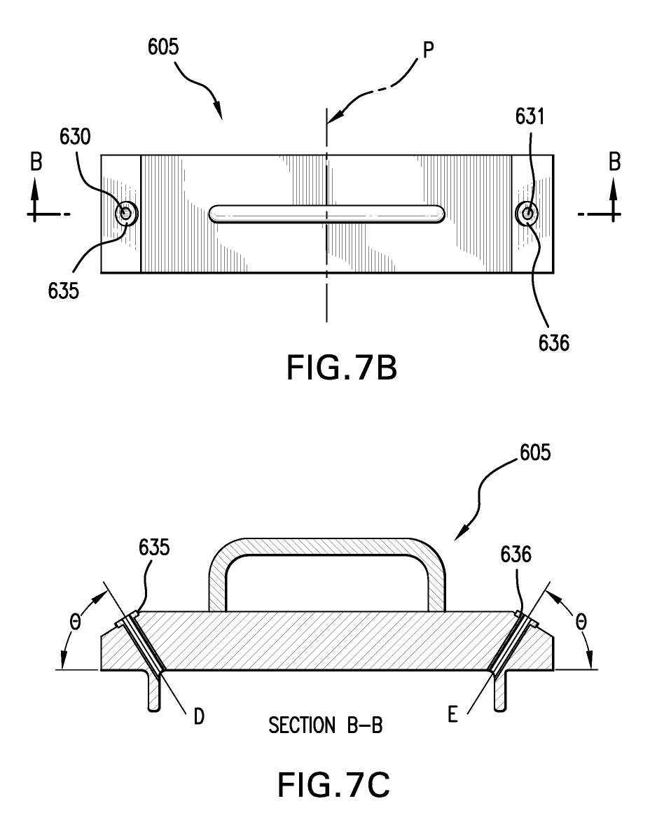

Referring to FIGS. 7A to 7C, an installation pilot device 605 includes many features in common with the installation pilot device 5 described above. Installation pilot device 605 differs, however, in that it has a pair of oppositely disposed bores 630 and 631 that extend through the grommets 635 and 636. Although the axes D and E of the bores 630 and 631 are at an angle theta that is the same (as well as being the same as the angle theta described above with respect to installation pilot device 5), it should be appreciated that the bores 630 and 631 may be formed at different angles with respect to each other.

The installation pilot device 605, when viewed from the top as in FIG. 7B, is symmetric about both a vertical plane that includes line B-B and a vertical plane P that is perpendicular to the vertical plane that includes line B-B. This symmetry allows the installation pilot device 605 to be placed onto the first construction member 400 in either orientation. Further, the installation pilot device 605 does not need to be reversed in order to drive fasteners 300 into the opposite sides of the first construction member 400, which is received between first and second positioning stops 615 and 620. Thus, the first construction member 400 could be pushed toward the adjacent first construction member 401 and a fastener 300 driven through the first bore 630 in like manner to that described above with respect to FIG. 6A. Without moving the installation pilot device 605, the opposite fastener 300 is then driven through the opposite bore 631. Thus, the same fastened article as illustrated in FIG. 6C is formed, but without the need to reverse the installation pilot device. This may reduce the time required to install the first construction member 400.

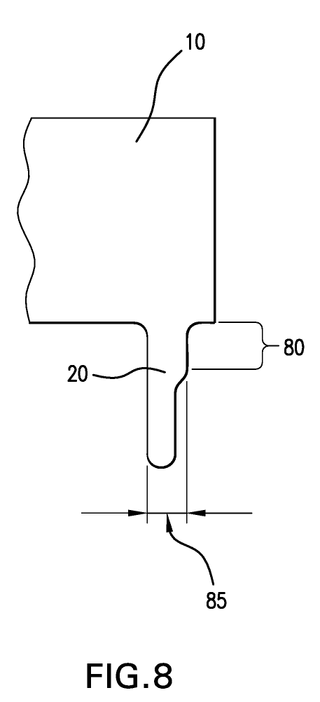

Referring to FIG. 8, the installation pilot device 5 may have a positioning stop 20 that has a stepped geometry, with a spacing portion 80 that extends downward for a distance, e.g., 0.2 inches, and has a width 85 corresponding to a desired spacing between the decking, e.g., 3/16 or ¼ of an inch. This stepped design reduces friction between the positioning stop 20 and the adjacent first construction member 401, thus facilitating removal of the installation pilot device 5 after driving fasteners 300. It should be noted that this geometry may be provided for both of the positioning stops 615 and 620 of the installation pilot device 605.

To further limit friction and facilitate removal of the installation pilot device from between fastened construction members, any of the first and/or second positioning stops described herein, e.g., position stops 15, 20, 115, 615, and 620, may have a low-friction coating, e.g., a polytetrafluoroethylene coating.

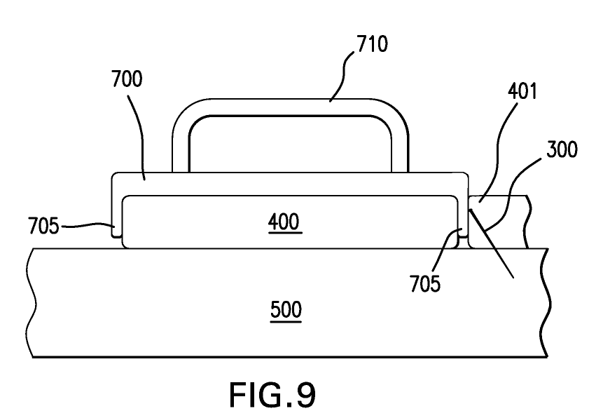

Referring to FIG. 9, a spacer 700 may be provided to set the spacing between adjacent first construction members. The spacer 700 is symmetric and includes two spacing projections 705 that are dimensioned to provide a desired spacing, e.g., 3/16 or ¼ of an inch. The spacing projections 705 are spaced apart at a distance corresponding to the width of the first construction member 400, which is received between the spacing projections 705 when the spacer 700 is coupled to the first construction member 400. The spacer 700 includes a nub 710 to facilitate manual gripping of the spacer 700 during removal from the first construction member 400. One or more of the C-shaped spacers 700 may be inserted over the width of the first construction member 400 to set the spacing between adjacent construction members. According to an example method, two spacers may be coupled to the first construction member 400 toward opposite longitudinal ends thereof. The installation pilot device is then used to drive the fasteners 300 into the first construction member 400 as described above with respect to FIGS. 6A to 6C. However, the positioning stops would not need to set the spacing, as the spacers 700 would perform this function. Thus the width of the positioning stops could be less than the desired spacing between adjacent first construction members.

It should be appreciated, however, that according to other methods and examples, the installation pilot device may set the spacing along with at least one spacer 700. Since the spacer 700 extends down both lateral sides of the first construction member 400, it can be left in place when the next adjacent construction member is installed next to the first construction member 400 on the side opposite the adjacent first construction member 401. This may reduce the number of times the spacer or spacers 700 need to be moved, as they may be coupled to every other first construction board that is sequentially installed, thus reducing the required labor and associated installation costs.

According to an example method, the spacers 700 are coupled toward opposite ends of the first construction member 400. The fasteners 300 are then driven at each of the opposite outer ends of the first construction member 400, e.g., as described above with respect to FIGS. 6A to 6C. Once the fasteners 300 are set at the ends of the first construction member 400, the spacers 700 may be removed since the opposite ends are set in spaced relationship by the fasteners 700. For longer lengths of the first construction member 400, it may be advantageous to provide at least one spacer 700 between the two outer spacers 700, and setting the fasteners 300 at least one intermediate location prior to removing the spacers 700. In an example method, the spacers are placed at the outer ends, the fasteners 300 driven at the outer ends, and at least one of the spacers is then moved to a position between the two outer positions, after which additional fasteners are driven and the at least one of the spacers is optionally removed. At this point the remainder of the fasteners 300 are driven to secure the first construction member 400 to the joists.

It should be appreciated that the spacing projections 705 may have the same geometry as the positioning stop 20 illustrated in FIG. 8 and/or be provided with a low-friction coating, e.g., a polytetrafluoroethylene coating. In this regard, the spacing projections 705 may be tapered so that the thickness of the spacing projections 705 decreases as they extend downward. The spacers 700 may be formed from any appropriate material, e.g., injection molded or extruded plastic, or metal.

The use of the spacers 700 in conjunction with the installation pilot device may save time during installation, as the spacers 700, spaced at intervals along the first construction members, may prevent any pinching of the positioning stops between adjacent first construction members.

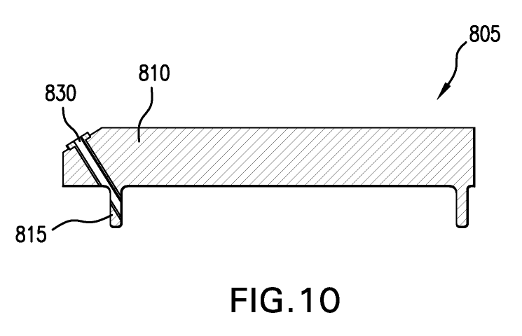

FIG. 10 is a cross sectional view of an installation pilot device 805 according to an example embodiment of the present invention. The installation pilot device 805 includes many features in common with the installation pilot devices described above. For simplicity, a handle is not illustrated, but it should be appreciated that the installation pilot device 805 may have any appropriate handle such as, e.g., the handle 25 described above. The installation pilot device 805 has a bore 830 that clips an interior corner of the body 810 of the device, the corner formed at the intersection of the lower surface of the body and the first positioning stop 815. Thus the bore 830 is laterally exposed or open in this region. Because of, e.g., the rounded corners of the first construction members 400, the threads and/or the cap portions of the fasteners 350 or 305 do not contact the corner or upper surfaces of the first construction member 400 into which a fastener is driven. This design may allow the screws to be driven at preferred angles that are not limited by the thickness of material of the installation pilot device between the bore and the first construction member. For example, the angle is not limited by the wall thickness of the grommet, since the wall is not present in the region of the corner of the first construction member 400.

Uplift resistance testing was performed on decking material installed with an installation pilot fastening system according to an example embodiment of the present invention. The tests were conducted for code compliance evaluation in accordance with the following criteria:
ICC-ES™ AC174 (Mar. 1, 2007), Acceptance Criteria for Deck Board Span Ratings and Guardrail Systems (Guards and Handrails).
The scope of testing was limited to Subsection 4.1.4—Mechanical Fastener Tests.

The decking board was an extruded composite material composed of cellular PVC reinforced with high-aspect inorganic modifiers and intended for use as an exterior walking deck board. The mixture used in the processing of the product was extruded through a continuous feed system and produced as a deck board measuring a nominal 1 inch thick and 5½ inches wide with ¼ inch radius edges. The top surface had an embossed simulated wood-grain pattern. Test specimens included four different colored products, the color differences being the result of different pigments in the composite material.

All test specimen materials were stored in laboratory ambient conditions with temperature in the range of 68±4° F. for no less than 40 hours prior to testing.

The reference Standards were as follows:
ASTM D 7032-04, Standard Specification for Establishing Performance Ratings for Wood-Plastic Composite Deck Boards and Guardrail Systems (Guards or Handrails)
ASTM E 330-97, Standard Test Method for Structural Performance of Exterior Windows, Curtain Walls and Doors by Uniform Static Air Pressure Difference

The general purpose of this testing was to determine the ultimate uplift resistance of installed decking installed with the installation pilot hidden fastening system, in accordance with an example embodiment of the present invention. Testing was conducted in accordance with Section 4.1.4 of AC174 using the methods described in ASTM E 330.

Fifteen (15) specimens were cut to lengths of 51 inches from the decking material to address a two-span application using four (4) support joists on 16 in centers for testing.

Three (3) deck mock-ups were constructed from 2×8 Southern-Yellow-Pine (SYP) lumber, each approximately 65 inches by 83 inches. Each mock-up consisted of five (5) deck specimens each attached to four (4) 63 inch long joists for a three-span condition. The unused area of the deck mock-up was filled with ½ inch plywood sheets and blocking. To retain air pressure on the specimens during testing, a layer of 4-mil thick polyethylene plastic was loosely draped between the joists of the mock-up prior to securing the test specimens and plywood to the lumber frame. The outboard edge of the first specimen was attached to each joist with a single #8×2½ inch Fin/Trim head deck screw to simulate face fastening. The other side of these specimens and the remaining four (4) specimens were fastened to the deck mock-up with one (1) #8×2½ inch Fin/Trim head deck screw per joist using the installation pilot device, which guided the screw through the edge of the decking at a 58° angle.

The uplift testing was performed in a 70±4° F. environment. Test specimens were assembled to the deck mock-ups and tested within two hours of removal from the laboratory conditions.

An assembled deck mock-up was inverted and placed upside down on a vacuum chamber constructed of structural steel channels. The lumber framing of the mock-up rested on the chamber walls. Test specimens were not supported by the vacuum chamber walls. The mock-up to chamber interface was sealed for air-tightness. The plastic covered underside of the deck specimens was exposed to atmospheric pressure. A negative static air pressure was applied to the vacuum chamber, creating an uplift pressure on the underside of all deck boards simultaneously. Differential pressure was measured using a differential pressure transducer. Differential pressure was increased incrementally and held for ten seconds until deck board failure.

| | Maximum | |
|---|---|---|
| | Sustained | |
| | Uplift Load | |
| Test | (psf)¹ | Comments |
| 1 | 706 | Two boards broke, all screws |
| | | remained attached to the deck |
| | | mock-up |
| 2 | 754 | Pressure transducer maxed out; all |
| | | deck board specimens intact |
| 3 | 636 | One deck board broke, all screws |
| | | remained attached to the deck |
| | | mock-up |
| Average | 699 | |

¹Held for 10 seconds

Based on these results, it was determined that the allowable uplift capacity based on a factor of safety of 3.0 (from Section 5.6 of ASTM D 7032) is 699 psf/3.0=233 psf. This result represents an over 100% increase from the 100 psf rating that deck board is expected to achieve.

Although the present invention has been described with reference to particular examples and embodiments, it should be understood that the present invention is not limited to those examples and embodiments. Moreover, the features of the particular examples and embodiments may be used in any combination. The present invention therefore includes variations from the various examples and embodiments described herein, as will be apparent to one of skill in the art.

What is claimed is:

1. An installation pilot device for facilitating the joining of a first construction member to a second construction member, the installation pilot device comprising:
a base having a bottom surface and a top surface, the bottom surface being arranged to couple to a top surface of the first construction member;
a bore extending through the base at an angle in the range from 50 to 70 degrees with respect to the lower surface, the bore configured to receive a fastener to be driven therethrough;
a first positioning stop and a second positioning stop, each of the first and second positioning stops extending from the lower surface, the first and second positioning stops configured to receive the first construction material therebetween when the lower surface is coupled to the top surface of the decking board; and
an immovable handle attached to the top surface of the base,
wherein the base, the first positioning stop, and the second positioning stop are formed as a single monolithic piece.

2. The installation pilot device according to claim 1, wherein the angle is in the range from 55 to 65 degrees.

3. The installation pilot device according to claim 2, wherein the angle is in the range from 57 to 61 degrees.

4. The installation pilot device according to claim 3, wherein the angle is about 59 degrees.

5. The installation pilot device according to claim 1, wherein the first and second positioning stops are spaced apart by a predetermined distance selected to accommodate a width of the first construction member.

6. An installation pilot device, comprising:
a base having a lower surface arranged to couple to a top surface of a decking board;
a first bore extending through the base and forming an angle selected from a range of 50 to 70 degrees with respect to the lower surface;
a second bore extending through the base and forming an angle selected from a range of 50 to 70 degrees with respect to the lower surface, axes of the first and second bores being coplanar and non-parallel with respect to each other;
a first positioning stop and a second positioning stop, each of the first and second positioning stops extending from the lower surface, the first and second positioning stops configured to receive the decking board therebetween when the lower surface is coupled to the top surface of the decking board; and
a handle attached to the base.

7. The installation pilot device according to claim 6, wherein the device is symmetric about at least two planes.

8. The installation pilot device according to claim 7, wherein one of the at least two planes is the plane that contains the axes of the first and second bores.

9. The installation pilot device according to claim 8, wherein at least one of the at least two planes is perpendicular to the plane that contains the axes of the first and second bores.

10. The installation pilot device according to claim 6, wherein the magnitude of the angle formed by the first bore is the same as the magnitude of the angle formed by the second bore.

11. The installation pilot device according to claim 10, wherein the angles formed by the first and second bores are selected from a range of 55 to 65 degrees.

12. The installation pilot device according to claim 11, wherein the angles formed by first and second bores are selected from a range of 57 to 61 degrees.

13. The installation pilot device according to claim 12, wherein the angles formed by the first and second bores are about 59 degrees.

14. A fastened article consisting essentially of:
a decking board having a bottom surface and two adjacent side surfaces at right angles to the bottom surface;
a joist having a top surface, the fastener extending through the top surface of the joist to connect the decking board to the joist; and
a plurality of fasteners, each having an axis that intersects each of (a) one of the side surfaces of the decking board, (b) the bottom surface of the decking board, and (c) the top surface of the joist, thereby connecting the decking board to the joist, the fastener forming an angle of about 59 degrees with respect to the bottom surface,
wherein the board is formed from a composite building material, the composite building material including a foamed substrate having a foamed inner core and a dense integral skin, wherein the foamed substrate comprises a polymer matrix and a reinforcing filler.

15. The fastened article according to claim 14, wherein the plurality of fasteners are the only fasteners connecting the decking board to the joist.

16. The fastened article of claim 14, wherein the fastener is a screw.

17. The fastened article of claim 14, wherein the composite building material further includes a urethane/acrylic coating applied to at least one surface of the foamed substrate, wherein the coating comprises an IR-reflective pigment and wherein the urethane/acrylic coating is chemically and/or physically bound to the substrate

18. A method of joining a decking board to a joist, comprising:
placing a decking board on a joist;
positioning an installation pilot over the decking board, the installation pilot including a bore forming a predefined angle with the decking board;
placing a fastener into the bore of the installation pilot; and
driving the fastener through the bore into a side surface of the decking board and through a bottom surface of the decking board and through a top surface of the joist, the fastener being driven to a depth that conceals the fastener when the decking board is viewed from above, wherein the decking board is formed from a composite building material, the composite building material including a foamed substrate having a foamed inner core and a dense integral skin, and wherein the foamed substrate comprises a polymer matrix and a reinforcing filler.

19. The method according to claim 18, wherein the installation pilot includes a locating structure extending below the plane of the top surface of the decking board when the installation pilot is positioned over the decking board.

20. The method according to claim 18, wherein the predefined angle is in the range of 50 to 70 degrees.

21. The method according to claim 20, wherein the predefined angle is in the range of 55 to 65 degrees.

22. The method according to claim 21, wherein the predefined angle is in the range of 57 to 61 degrees.

23. The method according to claim 22, wherein the predefined angle is about 59 degrees.

24. The method according to claim 18, further comprising coupling a spacer to the decking board, the spacer being separate from the installation pilot.

25. The method according to claim 24, wherein the spacer includes two spacing projections that extend downwardly to contact respective opposite side surfaces of the decking board.

26. The method according to claim 25, wherein the spacing projections are tapered.

27. The method according to claim 24, wherein a plurality of spacers are coupled to the decking board.

28. The method according to claim 18, wherein the composite building material further includes a urethane/acrylic coating applied to at least one surface of the foamed substrate, wherein the coating comprises an IR-reflective pigment and wherein the urethane/acrylic coating is chemically and/or physically bound to the substrate.
